(19) United States
(12) Patent Application Publication
(10) Pub. No.: US 2025/0344038 A1
(43) Pub. Date: Nov. 6, 2025

(54) VERIFICATION OF UE LOCATION FOR WIRELESS NETWORKS BASED ON SIGNAL TIMING MEASUREMENTS

(71) Applicant: Nokia Technologies Oy, Espoo (FI)

(72) Inventors: Ryan KEATING, Chicago, IL (US); Konstantinos MANOLAKIS, Munich (DE); Frank FREDERIKSEN, Klarup (DK); Jeroen WIGARD, Klarup (DK); Oana-Elena BARBU, Aalborg (DK); Rafhael MEDEIROS DE AMORIM, Aalborg (DK)

(21) Appl. No.: 18/870,847

(22) PCT Filed: Jun. 6, 2022
(86) PCT No.: PCT/US2022/072787

§ 371 Date: Dec. 2, 2024

(51) Int. Cl. H04W 4/02; G01S 5/00; G01S 5/02

(52) U.S. Cl. CPC H04W 4/025; G01S 5/0027; G01S 5/0244

(57) ABSTRACT

According to example embodiments, a method may include receiving, by a measuring device from a network entity, a request to perform location verification measurements for a user device in a wireless network; receiving, by the measuring device from the user device, reference signals; determining, by the measuring device, a plurality of timing measurements and an associated time stamp for each timing measurement, for the received reference signals; and transmitting, by the measuring device to the network entity, the timing measurements and associated time stamps, for use by the network entity to verify whether a reported location of the user device matches an actual location of the user device.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G and 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a method may include receiving, by a measuring device from a network entity, a request to perform location verification measurements for a user device in a wireless network; receiving, by the measuring device from the user device, reference signals; determining, by the measuring device, a plurality of timing measurements and an associated time stamp for each timing measurement, for the received reference signals; and transmitting, by the measuring device to the network entity, the timing measurements and associated time stamps, for use by the network entity to verify whether a reported location of the user device matches an actual location of the user device.

An apparatus may include: at least one processor; and at least one memory including computer program code; the at least one memory and the computer program code configured to, with the at least one processor, cause the apparatus at least to: receive, by a measuring device from a network entity, a request to perform location verification measurements for a user device in a wireless network; receive, by the measuring device from the user device, reference signals; determine, by the measuring device, a plurality of timing measurements and an associated time stamp for each timing measurement, for the received reference signals; and transmit, by the measuring device to the network entity, the timing measurements and associated time stamps, for use by the network entity to verify whether a reported location of the user device matches an actual location of the user device.

According to an example embodiment, an apparatus may include means for receiving, by a measuring device from a network entity, a request to perform location verification measurements for a user device in a wireless network; means for receiving, by the measuring device from the user device, reference signals; means for determining, by the measuring device, a plurality of timing measurements and an associated time stamp for each timing measurement, for the received reference signals; and means for transmitting, by the measuring device to the network entity, the timing measurements and associated time stamps, for use by the network entity to verify whether a reported location of the user device matches an actual location of the user device.

According to an example embodiment, a non-transitory computer-readable storage medium may include instructions stored thereon that, when executed by at least one processor, are configured to cause a computing system to receive, by a measuring device from a network entity, a request to perform location verification measurements for a user device in a wireless network; receive, by the measuring device from the user device, reference signals; determine, by the measuring device, a plurality of timing measurements and an associated time stamp for each timing measurement, for the received reference signals; and transmit, by the measuring device to the network entity, the timing measurements and associated time stamps, for use by the network entity to verify whether a reported location of the user device matches an actual location of the user device.

According to an example embodiment, a method may include receiving, by a network entity from a user device within a wireless network, a reported location of the user device; transmitting, by the network entity to a measuring device, a request to perform location verification measurements for the user device; receiving, by the network entity from the measuring device, timing measurements and an associated time stamp for each timing measurement measured by the measuring device for reference signals transmitted by the user device; and verifying, by the network entity, whether the reported location of the user device matches an actual location of the user device based at least on the received timing measurements and associated time stamps.

An apparatus may include: at least one processor; and at least one memory including computer program code; the at least one memory and the computer program code configured to, with the at least one processor, cause the apparatus at least to: receive, by a network entity from a user device within a wireless network, a reported location of the user device; transmit, by the network entity to a measuring device, a request to perform location verification measurements for the user device; receive, by the network entity from the measuring device, timing measurements and an associated time stamp for each timing measurement measured by the measuring device for reference signals transmitted by the user device; and verify, by the network entity, whether the reported location of the user device matches an actual location of the user device based at least on the received timing measurements and associated time stamps.

According to an example embodiment, an apparatus may include means for receiving, by a network entity from a user device within a wireless network, a reported location of the user device; means for transmitting, by the network entity to a measuring device, a request to perform location verification measurements for the user device; means for receiving, by the network entity from the measuring device, timing measurements and an associated time stamp for each timing measurement measured by the measuring device for reference signals transmitted by the user device; and means for verifying, by the network entity, whether the reported location of the user device matches an actual location of the user device based at least on the received timing measurements and associated time stamps.

According to an example embodiment, a non-transitory computer-readable storage medium may include instructions stored thereon that, when executed by at least one processor, are configured to cause a computing system to receive, by a network entity from a user device within a wireless network, a reported location of the user device; transmit, by the network entity to a measuring device, a request to perform location verification measurements for the user device; receive, by the network entity from the measuring device, timing measurements and an associated time stamp for each timing measurement measured by the measuring device for reference signals transmitted by the user device; and verify, by the network entity, whether the reported location of the user device matches an actual location of the user device based at least on the received timing measurements and associated time stamps.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a diagram illustrating a wireless non-terrestrial network according to an example embodiment.

FIG. 3 is a diagram illustrating a UE that uses an actual or true location 310 of the UE to determine its time and frequency offset for uplink communication via a serving satellite, while providing a reported location to the network that is different from the actual or true location of the UE.

FIG. 4 is a diagram illustrating a network in which a LMF or other network entity determines or verifies whether a reported location of a UE matches an actual or true location of the UE.

FIG. 5 is a diagram illustrating an uplink timing curve 510 for a reported UE location of the, and an uplink timing curve 520 for an actual or true location of the UE according to an example embodiment.

FIG. 6 is a signal diagram illustrating operation of a network according to an example embodiment.

FIG. 7 is a flow chart illustrating operation of a measuring device according to an example embodiment.

FIG. 8 is a flow chart illustrating operation of a network entity (e.g., LMF) according to an example embodiment.

FIG. 9 is a block diagram of a wireless station or node (e.g., network node, user node or UE, relay node, or other node).

### DETAILED DESCRIPTION

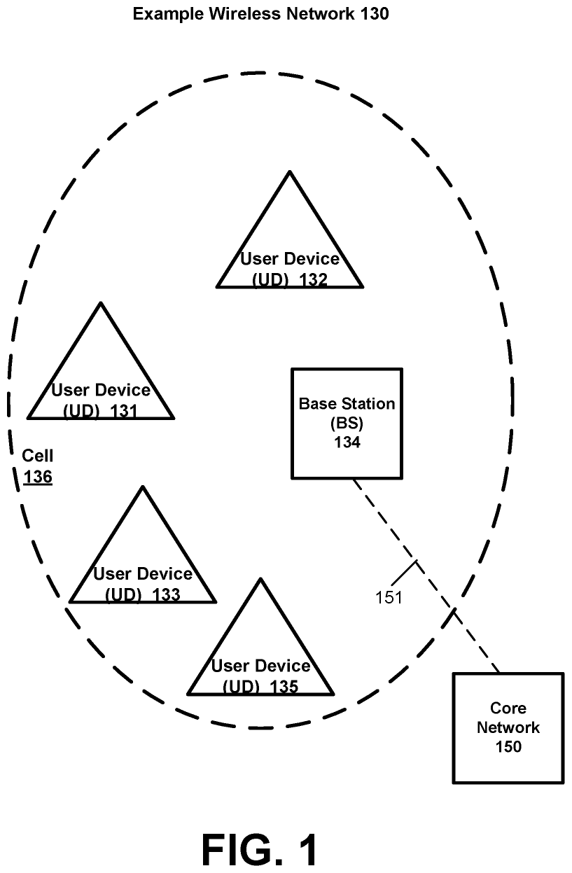

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS or split gNB). At least part of the functionalities of a BS (e.g., access point (AP), base station (BS) or (e)Node B (eNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a/centralized unit (CU) and/or a distributed unit (DU) in the case of a split BS or split gNB), or other network node.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device or user node (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, eNB, BS, AP, CU, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The techniques described herein may be applied to a wide variety of wireless technologies or wireless networks, such as LTE, LTE-A, 5G (New Radio (NR)), cmWave, and/or mmWave band networks, 6G, IoT, MTC, eMTC, eMBB, URLLC, etc., or any other wireless network or wireless technology. These example networks, technologies or data service types are provided only as illustrative examples.

A UE may adjust timing of its uplink transmission, depending on its location with respect to a serving gNB. For example, during a random access procedure, after receiving message 1 (random access preamble from the UE), a gNB may determine a receive timing of the received random access preamble. Based on the receive timing of the received preamble (if there are no collisions with other UEs), the gNB determines a timing advance (or TA or timing advance command) to adjust the timing of the UE uplink frame to align with a downlink frame (and also to align uplink receive timing with other UE uplink frames). Because each UE may be provided at a different location, each UE may have a different radio propagation delay, and thus a different or specific timing advance with respect to a gNB. Also, in some cases or for some networks (e.g., such as for a non-terrestrial wireless network), a UE may require both a timing offset and a frequency synchronization offset (or frequency offset) for uplink transmission.

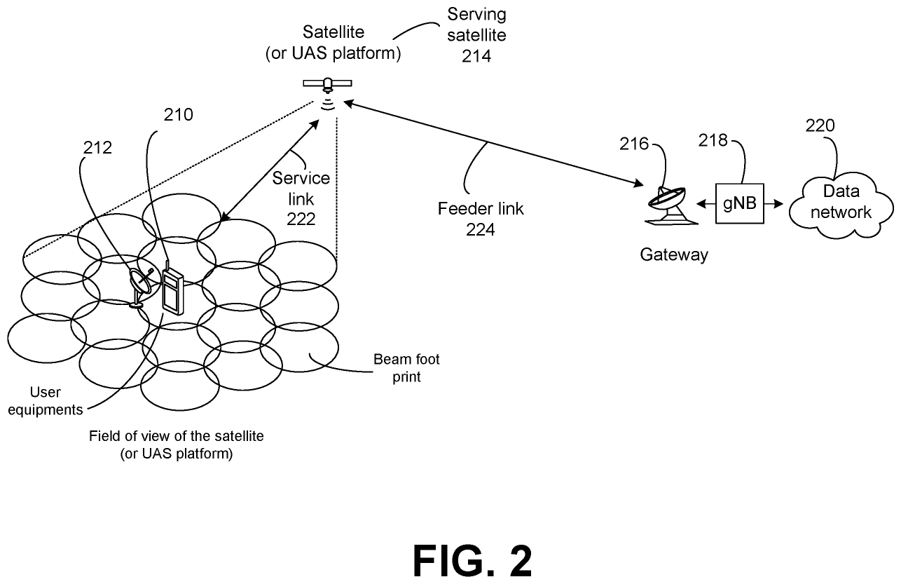

FIG. 2 is a diagram illustrating a wireless non-terrestrial network according to an example embodiment. The example non-terrestrial network shown in FIG. 2 may include a UE 210 that is in communication with a gNB (or network node) 218 via a serving satellite 214. The UE 210 may be able to directly transmit (e.g., via higher power transmitter and/or satellite dish antenna as part of the UE) to the serving satellite 214. Alternatively, the UE may be connected (or may be co-located with) a separate satellite antenna dish (e.g., which may be provided on a vehicle, a boat, a plane, within a building, etc.), to allow the UE 210 to transmit to the gNB 218 via the serving satellite 214. Other configurations for the UE and/or a satellite antenna for the UE may be provided as well, to allow the UE 210 to communicate via serving satellite 214 with gNB 218. Also, for example, gNB 218 may communicate with satellite 214 via a NTN gateway (GW) 216 (e.g., a satellite/gNB gateway, which may provide a conversion or interface between satellite communications (with satellite 214) and 5G/New Radio wireless communications (with gNB 218)). UE 210 may also include (within UE and/or as part of an external satellite antenna and transceiver connected to or in communication with UE 210) a similar GW or conversion block to allow the UE 210 to communicate via serving satellite 214. The gNB 218 may also be connected to a data network 220, such as the Internet or other data network. The wireless link between the UE 210 and serving satellite 214 may be referred to as the service link 222, while the wireless link between the gateway (GW) 216 and the serving satellite 214 may be referred to as the feeder link 224.

For example, gNB 218 may be located on the ground, and serving satellite 214 may perform frequency conversion and signal amplification. The GW 216 may be co-located with the gNB 218, or not. For example, the GW 216 may be at a location with a wireless link to the satellite 214, whereas the gNB 218 (e.g., including the baseband unit) may be at a location where is easy to maintain and operate the gNB, with a communications link provided between GW 216 and gNB 218. This is an illustrative example of a non-terrestrial wireless network and other networks and/or network configurations may be used. Also, the gNB 218 (either full gNB or partial gNB) may be provided on or within the serving satellite.

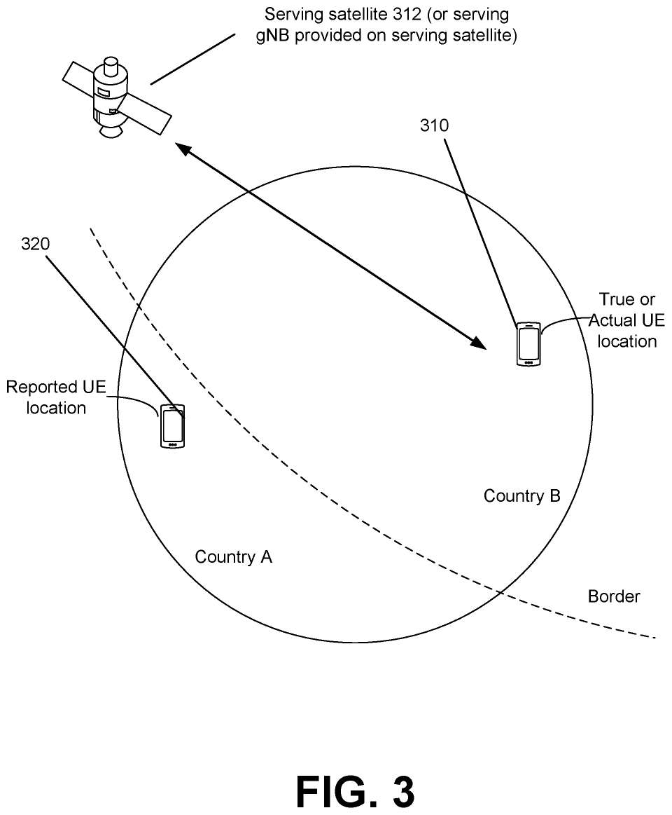

In the example non-terrestrial network shown in FIG. 3, the signal (or radio wave) propagation time between the gNB 218 and UE 210 covers both feeder link 224 and service link 222. The downlink (DL) signal received by the UE 210 will undergo a one-way propagation delay. If, for example, the uplink (UL) frame timing is to be aligned with the DL frame timing at the gNB 218, the UE 210 may need to apply a timing advance (TA) or a time (or timing) adjustment that is equal to the round-trip delay when transmitting UL data. Also, for example, this time adjustment should be accurate enough that the arrival time of an OFDM (orthogonal frequency division multiplexing) symbol is received within the gNB receiver's cyclic prefix window in order to keep signals from multiple UEs from interfering each other.

Moreover, due to a significant satellite speed of, e.g., approximately 7.5 km/s (relative to a stationary UE on the earth) for LEO (low earth orbit) deployments, the signal transmission on both service link 222 and feeder link 224 may typically be subject to a large frequency shift due to Doppler effect (or Doppler shift), mainly in form of a Doppler shift due to strong line of sight (LOS) character of both links. In an example embodiment, the feeder link Doppler shift (frequency shift of the received signal due to Doppler effect) in both downlink and uplink direction may be handled by the satellite subsystem (satellite 214 and NTN GW 216) in a way which is transparent to the gNB and UE, in an illustrative example.

However, for example, the UE 210 may still need to deal with (or compensate for) the Doppler shift on at least the service link 222, which may already span multiple subcarrier spacings (SCS), also depending on the elevation angle, for example. In the DL, this may require the UE to detect and compensate for a large frequency offset (or frequency error) caused by the Doppler shift, so that it can compensate for the frequency offset and detect the signal on the frequency grid and without significant inter-carrier interference (ICI). In the UL, the UE may need to pre-compensate for the Doppler shift on the service link so that the signal from all users/UEs reach the other end (e.g., gNB) of the link without large (relatively large) frequency offsets (or frequency errors) and (inter-user) ICI (inter-carrier interference) is avoided.

Therefore, UE 310 may adjust its carrier frequency in a way to pre-compensate for the service link Doppler shift. In order to determine a frequency adjustment to be applied as pre-compensation (to compensate for the Doppler shift on at least the service link 322), the UE 310 may use the so-called ephemeris information (location and speed vector of the serving satellite), which may be broadcasted regularly by the gNB 218 as part of the SIB (system information block), as well as the UE's own location. The serving satellite 314 may move on a predefined orbit, so location and speed of satellite may be sufficient information for the UE (or other nodes) to know the satellite's current and future positions, and/or path of the satellite.

The UE 310 may also have access to GNSS (Global Navigation Satellite Systems), such as GPS (Global Positioning System) signals. In this way, the UE 310 may be able to determine its own location. Based on its own location, and the location and speed of the serving satellite 314, the UE (or other nodes) may be able to determine UL time/frequency alignment, including determining a time synchronization error (time synchronization offset) and/or a frequency synchronization error (frequency synchronization offset) (e.g., which may be due to the Doppler effect of the moving satellite, or other movement, such as movement of the UE).

Furthermore, from time to time, or upon request, a UE may report its location (or position) to a serving gNB and/or to a location management function (LMF). A LMF may, for example, request and/or coordinate a positioning procedure to determine a location (position) of a UE, either a network based location determination, or a request to obtain the UE's location directly from the UE. The LMF may be provided, e.g., within a gNB, a network node or network entity with the core network, and/or located within the cloud or other location or within other network entity.

Thus, as noted, in some cases, such as for a NTN (non-terrestrial network) UE (e.g., a UE that may be connected to a serving gNB via a serving satellite), the UE may use its GNSS (e.g., GPS) location and the serving satellite's ephemeris information in order to determine how to transmit uplink towards the network (e.g., to determine an UL timing offset and a Doppler frequency offset pre-compensation for UL transmission). A UE may typically use (and is expected to use) its true location (or at least the most accurate estimate it can have based on GNSS-provided information, for example) to adjust or select the UL time (or UL timing) offset and frequency offset pre-compensation for uplink transmission, so that it may transmit uplink to the serving gNB.

However, a situation may arise where a UE may report an incorrect (or false or erroneous) location or position to the network (e.g., to its serving gNB or to a LMF), while using its actual or true location to determine or calculate uplink timing (e.g., a time offset and frequency offset to be used for uplink transmission). FIG. 3 is a diagram illustrating a UE that uses an actual or true location 310 of the UE to determine its time and frequency offset for uplink communication via (or to) a serving satellite 312, while providing a reported location 320 to the network that is different from the actual or true location 310 of the UE. As an illustrative example, a UE may report a false location to a network entity (e.g., gNB or LMF) in order to access different network services or access lower cost services that are offered by a different network or a different geographic region, wherein such network services or lower cost services may be inaccessible to the UE at its actual or true location. For example, as shown in FIG. 3, a UE that may be in country B (located at actual or true location 310) may falsely report its location as being within country A (reported UE location), e.g., in order to obtain wireless services or lower cost wireless services that may be available within country A and which are not available within country B (UE's actual or true location). Furthermore, a UE that may provide a false or inaccurate location reporting may use the same false location to select an (incorrect) public land mobile network (PLMN). In many cases, for example, the serving network node or network entity, e.g., satellite in case of non-transparent satellites (gNB located at or on the satellite) or gNB in case of transparent satellite (where the satellite may operate as a transparent relay providing all information to a ground station), may be unable determine based on the UL timing and/or frequency offset used by the UE for UL transmission whether the UE is reporting its true or actual location or not, as the UE UL transmission will appear well-synchronized from the network perspective. In other words, the network may be unable to differentiate the reported UE location/timing advance from the actual (or true) UE location/timing advance.

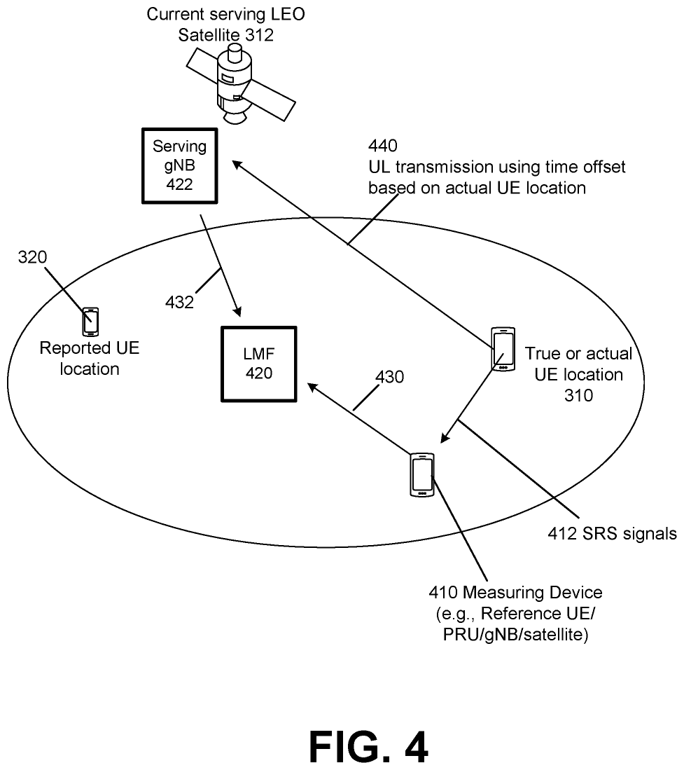

Therefore, various techniques are described that may allow a network entity (e.g., a gNB or LMF) to determine or verify whether a reported location of a UE matches an actual or true location of the UE. FIG. 4 is a diagram illustrating a network in which a LMF or other network entity determines or verifies whether a reported location of a UE matches an actual or true location of the UE. A UE may have a true or actual location 310, and a reported location 320. In this illustrative example embodiment, the UE may be served by a serving gnB and/or a serving satellite 312, e.g., as part of a non-terrestrial network (NTN). A LMF 420 is provided. A measuring device 410 may be provided, which may be, e.g., another UE, a positioning reference unit (PRU), another gNB, another satellite, or other network entity or node. The LMF 420 may send, to the serving gNB 422/serving satellite 312, a request to initiate a location verification procedure for the UE send a request to perform location verification measurements for the UE. LMF 420 may also send to measuring device 410 a request to perform location verification measurements for the UE. The UE, from its actual location 310, may transmit or broadcast reference signals, such as sounding reference signals (SRS signals) 412. The measuring device 410 may receive a configuration (e.g., indicating time frequency resources of the SRS signals) for the SRS signals to be transmitted by the UE. The measuring device 410, e.g., in response to the location verification measurement request, may perform timing measurements and obtain a time stamp for each measurement, based on the SRS signals received from the UE. For example, the timing measurements may include time of arrival measurements for the SRS signals, e.g., which may include at least one of: an absolute time of arrival of the received reference signal; or a relative time of arrival (RTOA) of the received reference signal with respect to a time reference, including with respect to at least one of: a subframe boundary; a system frame boundary; a received reference signal received from a network node; a common or known time reference (e.g., with respect to UTC time).

At 430, the measuring device 410 may transmit to the LMF 420, the timing measurements and an associated time stamp for each timing measurement measured by the measuring device 410 based on the reference signals transmitted by the UE. The LMF 420 may verify whether or not the reported location 320 of the UE matches an actual location 310 of the UE based at least on the received timing measurements and associated time stamps (that were received from the measuring device 410).

For example, the LMF 420 may determine, or may receive at 432 from the serving gNB 422 or serving satellite 312, information indicating (or associated with) an expected change of timing measurements for the UE, associated with the reported location 320 of the UE. For example, the information indicating or associated with an expected change of timing measurements for the UE over the period of time may include, e.g., the satellite ephemeris information for the serving satellite 312, or an expected change of timing measurements for the UE over the period of time comprises. The LMF 420 may determine, from the serving satellite ephemeris information and the reported UE location, the expected change of timing measurements for the period of time. The LMF 420 may verify whether the reported location 320 of the UE matches an actual location 310 of the UE by comparing a change of the received timing measurements over a period of time, to the expected change of timing measurements for the user device over the period of time. For example, if the reported location 320 of the UE matches the actual location 310 of the UE, then the change of received timing measurements over the period of time should match, or should be the same as, within some threshold (or within some allowed variation), the expected change of timing measurements over the period of time.

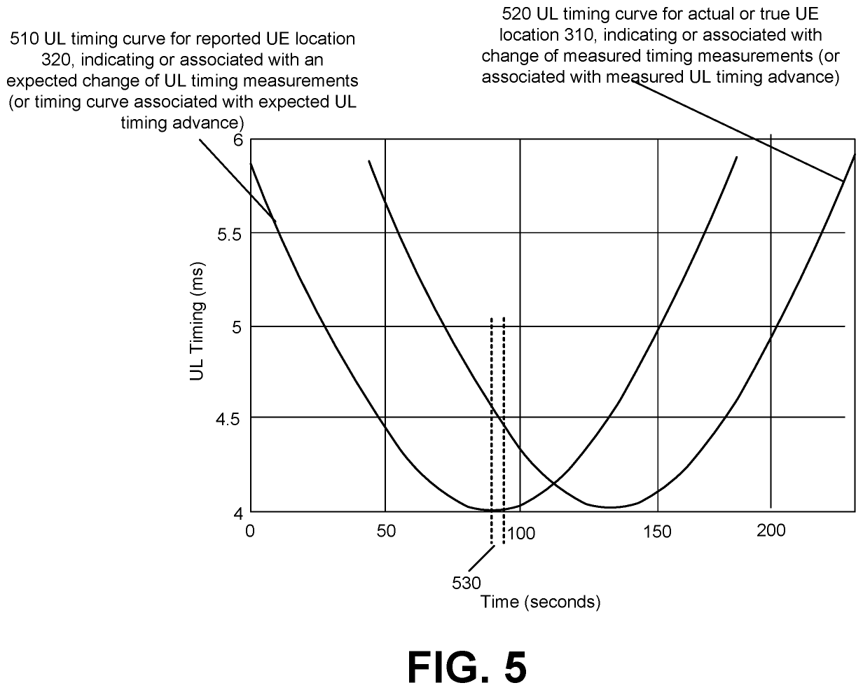

FIG. 5 is a diagram illustrating an uplink timing curve 510 for a reported UE location of the, and an uplink timing curve 520 for an actual or true location of the UE. The curve 510 for the reported UE location indicates the expected change in timing offset for the UE or expected change in timing measurements, e.g., the expected change of timing measurements or timing offset, as the serving satellite passes overhead, and the elevation for the satellite changes, from zero to 200+ seconds. The curve 520 for the actual or true location of the UE indicates or is associated with the change of the measured timing measurements received from the measuring device 410. At 530, two dotted vertical lines are marked indicating the time period (or time interval) from 92-95 seconds. In this illustrative example, this time period, from 92-95 seconds, corresponds to a period where, the UL timing curve 510 for the reported UE location is relatively flat or at the bottom of the curve, or relatively non-changing (e.g., provided at near a minimum of the UL timing curve 510, at a value of around 4 ms, for this time period or interval), just before starting it ascent back up. Thus, this UL timing curve 510 for reported UE location or associated with the expected change of timing measurements indicates that the expected change of timing measurements (as indicated by UL timing curve 510) should change very little, e.g., less than 1% between 92 and 95 seconds. Thus, the measured timing samples with time stamps of 92 seconds and 95 seconds may be subtracted from each other and divided by the average of these two samples to determine if the difference is less than 1%. If this difference if timing measurements is greater than or equal to 1%, then this may indicate that the actual or true location is not the same as the reported UE location. On the other hand, if the difference in the timing measurements (associated with actual or true UE location, based on SRS signals transmitted by the UE) is less than 1%, then the LMF 420 may determine or conclude that the true or actual location of the UE matches the reported location of the UE, in this example.

For example, the UL timing curve 520, in this example, which may (at least in some cases) represent or indicate the timing measurements from the measuring device, shows a change in the UL timing offset or a change in timing measurement for the actual location from 4.58 to 4.48 from 92 seconds to 95 seconds, which is greater than a 1% change. This is because the UL timing curve 520, based on timing measurements associated with the actual UE location has a steep descent during the time period of 92 seconds to 95 seconds (530), since this curve is not yet at a minimum or flat portion. Generally, the LMF may use received timing measurements received from the measuring device based on SRS signals transmitted by the UE, e.g., to calculate the change in timing measurements associated with the actual or true UE location, for a period of time (e.g., between 92 and 95 seconds).

This is merely one illustrative example technique that may be used to determine if the actual UE location matches the reported UE location, e.g., by comparing the measured change in timing measurements over a time period (e.g., a change in timing measurements received from the LMF, from the time period 92-95 seconds) to the expected change in timing measurements for the reported location, e.g., which may be indicated by UL timing curve 510 (which may be determined by the LMF based on reported UE location and satellite ephemeris information of the serving satellite). The LMF 420 may, for example, determine this UL timing curve 510 indicating an expected change of the UE UL timing or expected change of the timing measurements, based on the reported UE location and the ephemeris information of the serving satellite. Other techniques may be used as well, e.g., by comparing a slope of the UL timing curve 510 for a period of time, to a slope of the UL timing curve 520, for a period of time. If the slopes are different during this period of time, then this may indicate that the reported location is not the same as the actual or true location of the UE.

The curves 510 and 520 may indicate a change in UL timing for the UE, based on a reported location of the UE (UL timing curve 510) and the UL timing curve 520 for an actual or true UE location. However, at least for some cases, e.g., such as in a case of a static UE and a static measuring device 410, the curves or graphs of the timing measurements may change in a corresponding (e.g., a proportional) manner as the curves (510, 520) for the timing offset for the UE shown in FIG. 5. This is because the timing advance applied by the UE is changed by the UE in response to the satellite movement (or satellite ephemeris information) and actual UE location, and this change in timing advance will cause the timing measurements (e.g., time of arrival or relative time of arrival at measuring device of SRS signals transmitted by the UE) to correspondingly (e.g., in some cases proportionally) change at the measuring device. Thus, LMF 420 may verify (or determine) whether or not the reported location 320 of the UE matches an actual location 310 of the UE by comparing a change of the received timing measurements (the change of timing measurements provided by the measuring device based on SRS signals transmitted by the UE) over a period of time (e.g., over an interval or time period from 92-95 seconds), to the expected change of timing measurements (e.g., to the expected change of timing measurements as indicated by UL timing curve 510 for reported UE location, over an interval (or time period) 530 from 92-95 seconds) for the user device.

As noted, the LMF 420 may determine or may receive from the serving gNB, information indicating or associated with an expected change of timing measurements for the UE over the period of time, which may include, e.g., a plurality of expected timing measurements over or for the period of time, an expected change of timing measurements for the UE over the interval or period of time, or the satellite ephemeris information for the serving satellite. If expected timing measurements or expected change in timing measurements is received by the LMF 420, the LMF may compare the change in expected timing measurements (associated with a reported UE location) to the change in measured timing measurements (associated with the actual or true UE location). If the LMF 420 receives (as the information indicating or associated with an expected change of timing measurements for the UE over the period of time) the satellite ephemeris information of the serving satellite, the LMF 420 may first calculate (based on satellite ephemeris information and reported UE location) the UL timing curve 510 (or at least a portion thereof) for the expected change of timing measurements associated with the reported UE location, and then may determine the change of these expected timing measurements by determining corresponding TA or timing measurement values at beginning and end of the time period or interval (e.g., timing measurements at 92 seconds, and at 95 seconds, for interval 530, on UL timing curve 510). The LMF 420 may then compare the change in expected timing measurements (associated with a reported UE location, and calculated by LMF 420 based on the determined UL timing curve 510) to the change in measured timing measurements (associated with the actual or true UE location, and received by LMF 420 from the measuring device), in order to verify whether or not the actual or true location of the UE matches the reported UE location.

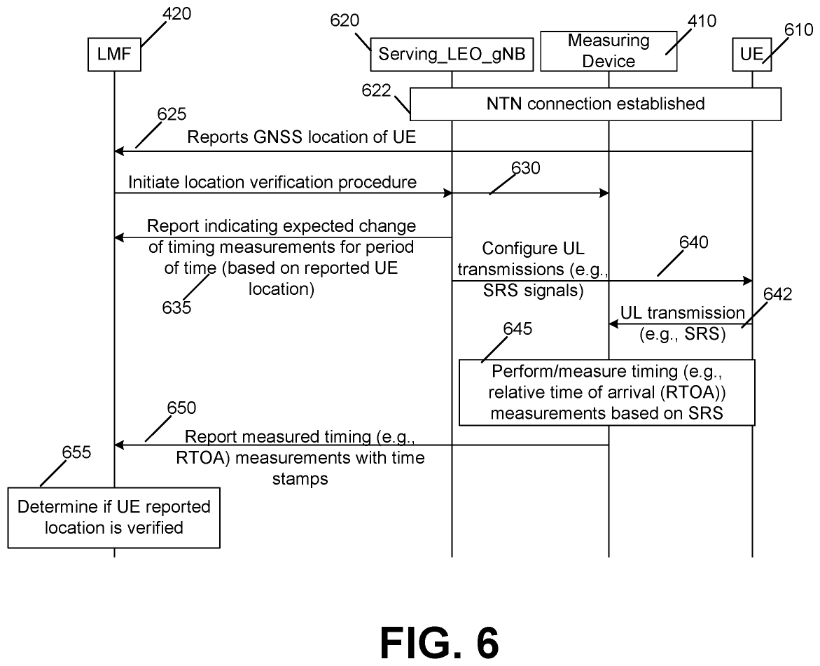

FIG. 6 is a signal diagram illustrating operation of a network according to an example embodiment. A UE 610 may be in communication with a serving gNB 620 (e.g., via a NTN (non-terrestrial network), such as via a serving satellite 312 (FIG. 3), at least in one example). Other networks may be used, including terrestrial networks. A measuring device 410 and a location management function (LMF) 420 are provided as well. The LMF 430 may be a network entity that may be used to coordinate positioning of the UE and/or verify the reported UE location, e.g., verify that the reported UE location of UE 610 matches (or sufficiently matches) the actual or true UE location for UE 610.

At 622, a connection (e.g., a non-terrestrial network (NTN) connection) is established between UE and the serving gNB 620 (e.g., which may be via a serving satellite 312, FIG. 3). At 625, the LMF 420 may receive a report from UE 610 that reports, or provides, a reported UE location. At 630, the LMF 420 sends a location verification procedure request for UE 610 to serving gNB 620, and LMF 420 sends a location verification measurement request for UE 610 to measuring device 410. For example, operations 635, 640, 645, 650 and 655 may be performed in response to the request for location verification of the UE 610.

At 635, the serving gNB 620 may send to LMF 420 information indicating, or associated with, an expected change of timing (e.g., expected change of RTOA) measurements for the UE 610 over a period of time, which may include, e.g., a plurality of expected timing measurements over an interval or period of time, an expected change of timing measurements for the UE over the interval or period of time, or the satellite ephemeris information for the serving satellite 312. At 640, the serving gNB 620 may configure the UE 610 to transmit SRS signals, e.g., indicating time/frequency resources for the SRS signals to be transmitted by UE 610. The SRS configuration may also be communicated to measuring device 410. At 642, the UE 610 transmits SRS signals. At 645, the measuring device may perform timing (e.g., relative time of arrival (RTOA)) measurements based on the received SRS signals. At 650, the serving gNB 620 may report to the LMF 420 the timing (e.g., RTOA) measurements and time stamp for each timing measurement.

At 655, LMF 420 may verify (or determine) whether or not the reported location 320 of the UE 610 matches an actual location 310 (FIG. 3) of the UE 610 by comparing a change of the received timing measurements (the change of timing measurements provided by the measuring device 410 based on SRS signals transmitted by the UE 610) over a period of time (e.g., over an interval or time period from 92-95 seconds), to the expected change of timing measurements (e.g., the expected change of timing measurements as indicated by UL timing curve 510 for reported UE location, over interval (or time period) 530 from 92-95 seconds) for the user device. For example, to verify that reported UE location is the same as actual or true UE location, the LMF 420 may verify or confirm that the change of the timing measurements (e.g., measured RTOA measured by the measuring device 410 based on SRS from UE, associated with actual or true UE location) from 92 to 95 seconds (or other time period) matches the change in the expected change of timing measurements as indicated by UL timing curve for reported UE location (associated with a reported UE location), within some threshold (e.g., within +/−2%), or that the slope of the change of timing measurements provided by measuring device 410 matches the slope of the change of expected timing measurements (e.g., matches the slope of the UL timing curve 510 for reported UE location) within some threshold or allowed variation, e.g., within +/−5%.

For example, the timing measurements provided by the measuring device 410 may indicate a change of RTOA from 4.58 ms (at 92 seconds) to 4.48 ms (at 95 seconds), for a total change of −0.1 ms within the time period. On the other hand, based on UE reported location and serving satellite ephemeris information, the LMF 420 may determine the UL timing curve 510 associated with reported UE location, and determine that from 92 seconds to 95 seconds, the RTOA or UL timing may change from 4.011 ms (at 92 seconds) to 4.015 (at 95 seconds), for a total change of RTOA or UL timing of +0.004 ms, which is a relatively flat UL timing, as shown by FIG. 5. Thus, LMF 420 may determine that the UL timing change of measured timing measurements (associated with true or actual location) changes −0.1 ms, whereas the expected change of timing measurements (associated with reported UE location) is only +0.004 ms. Because the change of measured timing measurements (0.1 ms) is more than 5% (an example threshold) greater than the expected change of timing measurements (0.004 ms) associated with the reported UE location, the LMF 420 may conclude or determine that the reported UE location does not match the actual or true UE location, according to this illustrative example. Also, in this example, the direction of change (a negative change, e.g., −0.1 ms) for the measured timing measurements is opposite of the direction of change of expected change of timing measurements (positive change of +0.004 ms, in this example), which may also indicate that the reported UE location does not match the actual or true UE location. Instead of a change in values, the slope or other measurement or calculation may be used to determine whether the measured change sufficiently matches the expected change of timing measurements. For example, if it is known that the slope of expected timing measurements of UL timing curve 510 is flat (approximately non-changing from 92-95 seconds), then the LMF 420 can simply determine whether the change of measured timing values within this time period changes more than a threshold, (e.g., more than 1%, more than 5% or more than 10%), and if so, this indicates that the reported UE location does not match (is not the same as) the actual or true UE location.

One or more actions may be performed by the LMF 420 if the reported UE location does not match the actual or true location of the UE. For example, if the reported UE location does not match the actual or true UE location, the LMF 420 may, e.g., send to the serving gNB, a node within a core network or the UE, a message indicating that the reported location of the UE does not match the actual location of the user device; or send to the serving gNB or a node within the core network, a message requesting a disconnection of the user device or a reduction in services or a reduction in a quality of service provided by the serving network node to user device, e.g., based on an erroneous reported UE location for UE 610. These are just some examples, and other actions may be performed.

Example embodiments are directed to a method(s) for using NR (New Radio) measurements at a measuring device (or vetting device) to determine if the location reported by the UE is the same as the actual location (for example verifying whether or not the UE is reporting a false location).

At least in some cases, if a UE is falsifying a location, i.e., reporting a false location (e.g., false GPS coordinates) to the serving gNB or to the LMF, then the UE will have to adapt or adjust its UL timing and Doppler frequency offset compensation to match what is needed at the true or actual UE location (that is, the UE may be reporting erroneous values for UE requested location through RRC (radio resource control)/MAC (media access control)/LPP (LTE positioning protocol) mechanisms or protocol entities and/or through the higher layer reporting, while the UE will need to use the correct timing advance and doppler compensation, based on its actual or true location, to meet transmission requirements for UL signal alignment).

If distance A is the distance between the UE and the serving satellite and distance B is the distance between the UE and another point in C (e.g., another satellite or reference UE/PRU or TN). This point C can be thought of as a measuring device, or may be referred to as a passive listener, a passive listening device, or a vetting device, e.g., since such measuring device may listen to received signals (e.g., based on received reference signals, such as SRS signals received from the UE) and measure timing measurements (e.g., RTOA) based on the received signals.

For example, at two points in time, symmetrically located around the symmetry point of the timing advance curve, the UE should use the same UL timing (assuming it hasn't moved too much in between). This point of symmetry depends on the UE location, i.e., is different for UEs at different locations, for a given serving satellite orbit.

If the UE timing (e.g., relative time of arrival), as observed at a third point C (e.g., next LEO or another UE) does not reflect the symmetry based on the serving satellite orbit in timing then this indicates that the UE location reported by the UE may be incorrect.

On the side of the reference point C this can be detected by using relative timing measurements (e.g., relative ToA between two UL transmissions) verification/detection. The TA value itself is not of interest, as what matters is the change in UL timing over time and whether this is in line with the expected behavior (i.e., when does it seem flat or when an unexpected jump occurs). The instantaneous doppler may also be considered when estimating the ToA. So, the measuring (or vetting) device, which may be another LEO satellite, gNb, positioning reference unit (PRU) or reference UE, measures the relative time of arrival over a period of time and reports this to the location server (LMF) which can then use this information to verify (or not) the location as reported by the UE in UL.

The reported time may be the absolute time of arrival, or the relative time of arrival between the UL transmission by the NTN UE (SFN (system frame number) U_x) and a Downlink transmission by the NTN gNB (SFN D_y). The measuring device should ideally not be configured with other signals in the same time frequency resources as the SRS from the UE.

Example embodiments may rely on the following signaling steps to complete the above described procedure: LMF initiates UE position verification process by sending a signal to the gNB serving the UE; gNB/LEO sends the expected TA/UL timing change for a period of time to the LMF; gNB configures UE with SRS, if not already configured; gNB informs LMF of the SRS configuration LMF asks vetting device and serving gNB/LEO to measure relative UL timing (RTOA) (e.g., when the measuring or vetting device is UE); LMF indicates to measuring device the SRS configuration used by the UE to be received and measured; LMF may inquire different units or nodes, UEs, etc., about their capabilities in detecting the SRS, and may select among them one or more to act as measuring or vetting devices. Measuring or vetting device may be another LEO satellite, a reference UE (or positioning reference unit), or other node or network entity. UE transmits SRS periodically and serving gNB/LEO plus measuring device measures RTOA.

Serving gNB/LEO satellite and measuring or vetting device may report RTOA measurements to LMF. In order to minimize the reports over the air interface, the LMF may establish triggers for the reporting of the measuring or vetting device. The Triggers may be associated with different causes such as: The differential ToA between different UL transmissions after X frames. The moment where the ToA (or doppler) changes inflection. When X readings are collected with their respective time stamps.

LMF compares RTOA measurements with expected RTOA measurements (or expected changes of RTOA measurements) and determines if UE reported location is verified. In one embodiment, the expected handover time can be used to compare or determine when a large (e.g., greater than a threshold) jump or change in UL timing is expected.

If the UE reported location is erroneous, the network may perform one or more corresponding actions.

In one embodiment, the measuring device or vetting device may be requested to also provide other link quality indicators e.g., RSRP (reference signal received power)/SINR (signal to interference plus noise ratio) of each SRS reception, and/or differential RSRP/SINR associated with RTOA, etc. Then, the LMF may use this information to determine how much/if to trust the reported RTOA measurements.

In some embodiments more than one measuring device may be used to assist the LMF in determining if the UE location is verified (or not). This may be done to reduce the evaluation time by having more measurement nodes (more measuring devices) or to add redundancy in case there is a NLOS (non-line of sight) link between the measuring device and the UE. If NLOS is a problem or not depends on the overall accuracy target needed for verification. For example, if 100 m accuracy of verification is needed then the errors from NLOS RTOA measurements are likely negligible.

The network can verify if the UE reported location is correct (same as actual or true UE location), which may result in a more reliable location estimation of the UE, as compared with simply blindly trusting that the UE reported location is correct.

Wireless services, and cost may be applied correctly to UEs based on actual location, not based on reported location, to avoid fraud.

Higher quality charging methods (e.g., based on country) may be performed.

The method has the advantage that the reference node C (e.g., measuring device, other than serving satellite or another UE) does not need to know or detect the actual TA applied by the UE (which would require additional signaling or decoding of UL information). It only measures and monitors the timing measurement such as a relative ToA from the UL transmission of SRS from the UE. Moreover, the measuring device does not need to know the UE location.

The network has the flexibility to instruct a certain UE (or UEs), or other nodes, to act as a measuring device (vetting device) or reference node. This has an advantage in case of multiple UEs being located closely, where nearby UEs can easily receive (strong) UL signals from other UEs and monitor the ToA, and then send a report to LMF to indicate measured RTOA of these received reference signals.

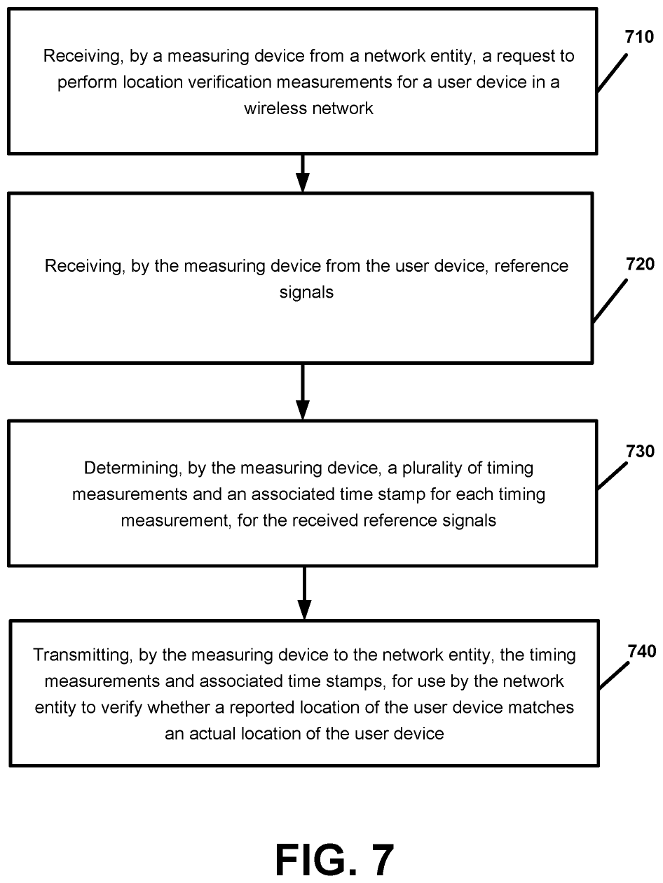

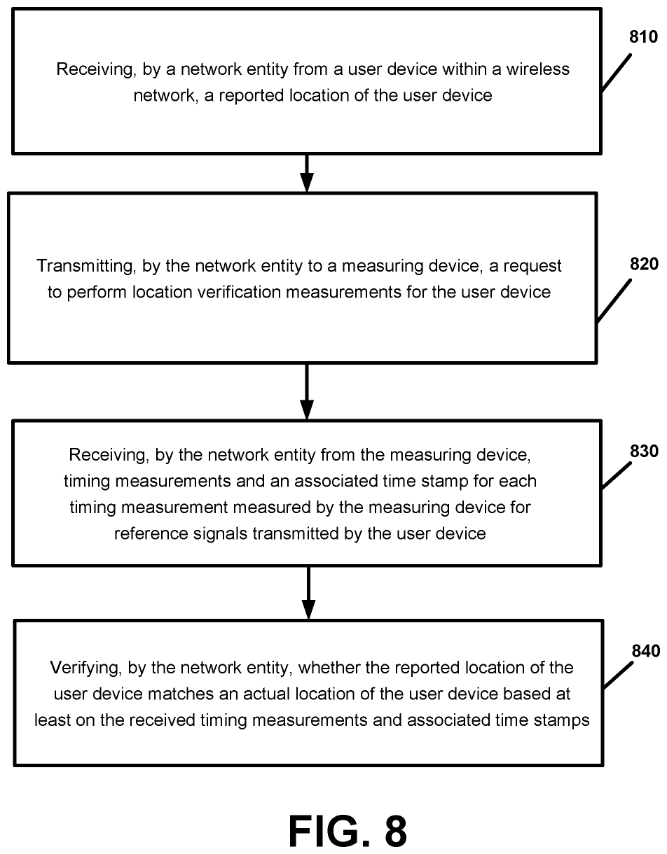

Some further examples will be provided.
Example 1. FIG. 7 is a flow chart illustrating operation of a measuring device according to an example embodiment. Operation 710 includes receiving, by a measuring device from a network entity, a request to perform location verification measurements for a user device in a wireless network. Operation 720 includes receiving, by the measuring device from the user device, reference signals. Operation 730 includes determining, by the measuring device, a plurality of timing measurements and an associated time stamp for each timing measurement, for the received reference signals. And, operation 740 includes transmitting, by the measuring device to the network entity, the timing measurements and associated time stamps, for use by the network entity to verify whether a reported location of the user device matches an actual location of the user device.
Example 2. The method of example 1, wherein the reference signals comprise uplink sounding reference signals, the method further comprising: receiving, by the measuring device, a configuration of the uplink sounding reference signals.
Example 3. The method of any of examples 1-2, wherein each of the transmitted timing measurements comprises a time of arrival measurement based on or including at least one of: an absolute time of arrival of the received reference signal; or a relative time of arrival of the received reference signal with respect to a time reference, including with respect to at least one of: a subframe boundary; a system frame boundary; a received reference signal received from a network node; a common or known time reference.
Example 4. The method of any of examples 1-3, wherein the transmitting, by the measuring device to the network entity, the timing measurements and associated time stamps comprises: determining, by the measuring device, that the timing measurements and associated time stamps satisfy a trigger condition; and transmitting, by the measuring device to the network entity, the timing measurements and associated time stamps, in response to the trigger condition being satisfied.
Example 5. The method of any of examples 1-4, wherein the transmitting, by the measuring device to the network entity, the timing measurements and associated time stamps comprises: determining, by the measuring device, that the timing measurements and associated time stamps satisfy a trigger condition associated with a mismatch between an actual location of the user device and the reported location of the user device; and transmitting, by the measuring device to the network entity the timing measurements and associated time stamps, in response to the trigger condition being satisfied.
Example 6. The method of example 5, wherein the trigger condition comprises at least one of the following: one or more of the timing measurements, at or within a specific period of time, is greater than a threshold; one or more of the timing measurements, at or within a specific period of time, is less than a threshold; a difference between two of the timing measurements, over a specific period of time, is greater than a threshold; a difference between two of the timing measurements, over a specific period of time, is less than a threshold; a change of received timing measurements, associated with an actual or real location of the user device, is different by more than a threshold of an expected change of timing measurements, associated with a reported location of the user device; a rate of change or slope of timing measurements, over a specific period of time, is less than a threshold; or a rate of change or slope of timing measurements, over a specific period of time, is greater than a threshold.
Example 7. The method of any of examples 1-6, wherein the network entity comprises a location management function (LMF).
Example 8. The method of any of examples 1-7, wherein the measuring device comprises at least one of the following: a user device or user equipment (UE); a positioning reference unit (PRU); or a base station, gNB or other network node.
Example 9. The method of any of examples 1-8, wherein the timing measurements and associated time stamps are transmitted to the network entity to enable to the network entity to verify that an actual location of the user device, represented by or associated with the transmitted timing measurements over a period of time, sufficiently matches or not a reported location of the user device.
Example 10. The method of any of examples 1-9, wherein the user device is connected to a serving network node via a serving satellite that is part of a non-terrestrial wireless network.
Example 11. An apparatus comprising means for performing the method of any of examples 1-10.
Example 12. A non-transitory computer-readable storage medium comprising instructions stored thereon that, when executed by at least one processor, are configured to cause a computing system to perform the method of any of examples 1-10.
Example 13. An apparatus comprising: at least one processor; and at least one memory including computer program code; the at least one memory and the computer program code configured to, with the at least one processor, cause the apparatus at least to perform the method of any of examples 1-10.
Example 14. An apparatus comprising: at least one processor; and at least one memory including computer program code; the at least one memory and the computer program code configured to, with the at least one processor, cause the apparatus at least to: receive, by a measuring device from a network entity, a request to perform location verification measurements for a user device in a wireless network; receive, by the measuring device from the user device, reference signals; determine, by the measuring device, a plurality of timing measurements and an associated time stamp for each timing measurement, for the received reference signals; and transmit, by the measuring device to the network entity, the timing measurements and associated time stamps, for use by the network entity to verify whether a reported location of the user device matches an actual location of the user device.
Example 15. FIG. 8 is a flow chart illustrating operation of a network entity according to an example embodiment. Operation 810 includes receiving, by a network entity from a user device within a wireless network, a reported location of the user device. Operation 820 includes transmitting, by the network entity to a measuring device, a request to perform location verification measurements for the user device. Operation 830 includes receiving, by the network entity from the measuring device, timing measurements and an associated time stamp for each timing measurement measured by the measuring device for reference signals transmitted by the user device. Operation 840 includes verifying, by the network entity, whether the reported location of the user device matches an actual location of the user device based at least on the received timing measurements and associated time stamps.
Example 16. The method of example 15, wherein each of the transmitted timing measurements comprises a time of arrival measurement based on or including at least one of: an absolute time of arrival of a reference signal received by the measuring device; or a relative time of arrival of a reference signal received by the measuring device, wherein the relative time of arrival is provided with respect to a time reference, including with respect to at least one of: a subframe boundary; a system frame boundary; a received reference signal received by the measuring device from a network node; or a common or known time reference.
Example 17. The method of any of examples 15-16, wherein the receiving, by the network entity from the measuring device, the timing measurements and associated time stamps comprises: receiving, by the network entity from the measuring device the timing measurements and associated time stamps, in response to a trigger condition, associated with a mismatch between an actual location of the user device and the reported location of the user device, that is detected by the measuring device as being satisfied.
Example 18. The method of example 17, wherein the trigger condition comprises at least one of the following: one or more of the timing measurements, at or within a specific period of time, is greater than a threshold; one or more of the timing measurements, at or within a specific period of time, is less than a threshold; a difference between two of the timing measurements, over a specific period of time, is greater than a threshold; a difference between two of the timing measurements, over a specific period of time, is less than a threshold; a change of received timing measurements, associated with an actual or real location of the user device, is different by more than a threshold of an expected change of timing measurements, associated with a reported location of the user device; a rate of change or slope of timing measurements, over a specific period of time, is less than a threshold; or a rate of change or slope of timing measurements, over a specific period of time, is greater than a threshold.
Example 19. The method of any of examples 15-18, wherein the verifying comprises: verifying, by the network entity that an actual location of the user device, represented by the received timing measurements over a period of time, sufficiently matches or not a reported location of the user device, represented by information indicating or associated with an expected change of timing measurements for the user device over the period of time.
Example 20. The method of any of examples 15-19, further comprising: determining, by the network entity, information indicating or associated with an expected change of timing measurements for the user device, associated with the reported location of the user device; and wherein the verifying comprises: verifying, by the network entity, whether the reported location of the user device matches an actual location of the user device by comparing a change of the received timing measurements over a period of time, to the expected change of timing measurements for the user device over the period of time.
Example 21. The method of any of examples 19-20: wherein the user device is connected to a serving network node via a serving satellite that is part of a non-terrestrial wireless network; and wherein the information indicating or associated with an expected change of timing measurements for the user device over the period of time comprises at least satellite ephemeris information for the serving satellite.
Example 22. The method of any of examples 19-22, wherein the information indicating or associated with an expected change of timing measurements for the user device over the period of time comprises at least one of: a plurality of expected timing measurements for the user device, associated with the reported location of the user device; or an expected change of timing measurements for the user device, associated with the reported location of the user device.
Example 23. The method of example 21, further comprises receiving a reported location of the user device, wherein the verifying whether the reported location of the user device matches an actual location of the user device comprises: determining, by the network entity, the expected change of timing measurements for the user device associated with the reported location of the user device over a period of time, based on the reported user device location and the satellite ephemeris information of the serving satellite; determining, by the network entity, the change of the received timing measurements over the period of time; and determining, by the network entity, whether the expected change of timing measurements over the period of time matches, within a threshold, the change of the received timing measurements over the period of time.
Example 24. The method of any of examples 15-23, wherein the verifying, by the network entity, whether the reported location of the user device matches the actual location of the user device based on determining at least one of the following: one or more of the received timing measurements, over a specific period of time, is greater than a threshold; one or more of the received timing measurements, over a specific period of time, is less than a threshold; a difference between two of the received timing measurements, over a specific period of time, is greater than a threshold; a difference between two of the received timing measurements, over a specific period of time, is less than a threshold; a rate of change or slope of the received timing measurements, over a specific period of time, is less than a threshold; or a rate of change or slope of the received timing measurements, over a specific period of time, is greater than a threshold.
Example 25. The method of any of examples 15-24, wherein the network entity comprises a location management function (LMF).
Example 26. The method of any of examples 15-25, further comprising: performing, by the network entity based on the verifying, an action with respect to the user device if the reported location of the user device does not match the actual location of the user device.
Example 27. The method of examples 26, wherein performing the action comprises performing at least one of the following: sending, by the network entity, to the serving network node, a node within a core network or the user device, a message indicating that the reported location of the user device does not match the actual location of the user device; or sending, by the network entity, to the serving network node or a node within the core network, a message requesting a disconnection of the user device or a reduction in services or a reduction in a quality of service provided by the serving network node to user device.
Example 28. An apparatus comprising means for performing the method of any of examples 15-27.
Example 29. A non-transitory computer-readable storage medium comprising instructions stored thereon that, when executed by at least one processor, are configured to cause a computing system to perform the method of any of examples 15-27.
Example 30. An apparatus comprising: at least one processor; and at least one memory including computer program code; the at least one memory and the computer program code configured to, with the at least one processor, cause the apparatus at least to perform the method of any of examples 15-27.
Example 31. An apparatus comprising: at least one processor; and at least one memory including computer program code; the at least one memory and the computer program code configured to, with the at least one processor, cause the apparatus at least to: receive, by a network entity from a user device within a wireless network, a reported location of the user device; transmit, by the network entity to a measuring device, a request to perform location verification measurements for the user device; receive, by the network entity from the measuring device, timing measurements and an associated time stamp for each timing measurement measured by the measuring device for reference signals transmitted by the user device; and verify, by the network entity, whether the reported location of the user device matches an actual location of the user device based at least on the received timing measurements and associated time stamps.

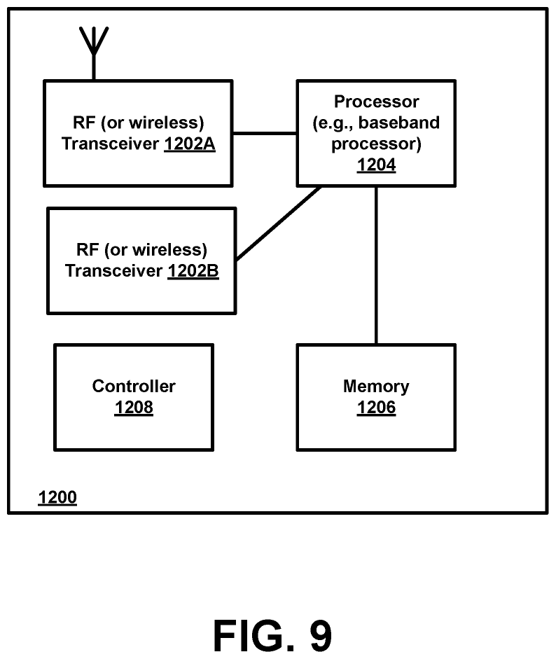

FIG. 9 is a block diagram of a wireless station or node (e.g., UE, user device, AP, BS, eNB, gNB, RAN node, network node, TRP, or other node) 1200 according to an example embodiment. The wireless station 1200 may include, for example, one or more (e.g., two as shown in FIG. 9) RF (radio frequency) or wireless transceivers 1202A, 1202B, where each wireless transceiver includes a transmitter to transmit signals and a receiver to receive signals. The wireless station also includes a processor or control unit/entity (controller) 1204 to execute instructions or software and control transmission and receptions of signals, and a memory 1206 to store data and/or instructions.

Processor 1204 may also make decisions or determinations, generate frames, packets or messages for transmission, decode received frames or messages for further processing, and other tasks or functions described herein. Processor 1204, which may be a baseband processor, for example, may generate messages, packets, frames or other signals for transmission via wireless transceiver 1202 (1202A or 1202B). Processor 1204 may control transmission of signals or messages over a wireless network, and may control the reception of signals or messages, etc., via a wireless network (e.g., after being down-converted by wireless transceiver 1202, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 1202 together may be considered as a wireless transmitter/receiver system, for example.

In addition, referring to FIG. 9, a controller (or processor) 1208 may execute software and instructions, and may provide overall control for the station 1200, and may provide control for other systems not shown in FIG. 9, such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example embodiment, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer, or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset.

Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1.-31. (canceled)

32. A method comprising:
receiving, by a measuring device from a network entity, a request to perform location verification measurements for a user device in a wireless network;
receiving, by the measuring device from the user device, reference signals;
determining, by the measuring device, a plurality of timing measurements and an associated time stamp for each timing measurement, for the received reference signals; and
transmitting, by the measuring device to the network entity, the timing measurements and associated time stamps, for use by the network entity to verify whether a reported location of the user device matches an actual location of the user device.

33. The method of claim 32, wherein the reference signals comprise uplink sounding reference signals, the method further comprising:
receiving, by the measuring device, a configuration of the uplink sounding reference signals.

34. The method of claims 32, wherein each of the transmitted timing measurements comprises a time of arrival measurement based on or including at least one of:
an absolute time of arrival of the received reference signal; or
a relative time of arrival of the received reference signal with respect to a time reference, including with respect to at least one of:
a subframe boundary;
a system frame boundary;
a received reference signal received from a network node;
a common or known time reference.

35. The method of 32, wherein the transmitting, by the measuring device to the network entity, the timing measurements and associated time stamps comprises:
determining, by the measuring device, that the timing measurements and associated time stamps satisfy a trigger condition; and
transmitting, by the measuring device to the network entity, the timing measurements and associated time stamps, in response to the trigger condition being satisfied.

36. The method of claim 32, wherein the transmitting, by the measuring device to the network entity, the timing measurements and associated time stamps comprises:
determining, by the measuring device, that the timing measurements and associated time stamps satisfy a trigger condition associated with a mismatch between an actual location of the user device and the reported location of the user device; and
transmitting, by the measuring device to the network entity the timing measurements and associated time stamps, in response to the trigger condition being satisfied.

37. The method of claim 36, wherein the trigger condition comprises at least one of the following:
one or more of the timing measurements, at or within a specific period of time, is greater than a threshold;
one or more of the timing measurements, at or within a specific period of time, is less than a threshold;
a difference between two of the timing measurements, over a specific period of time, is greater than a threshold;
a difference between two of the timing measurements, over a specific period of time, is less than a threshold;
a change of received timing measurements, associated with an actual or real location of the user device, is different by more than a threshold of an expected change of timing measurements, associated with a reported location of the user device;
a rate of change or slope of timing measurements, over a specific period of time, is less than a threshold; or
a rate of change or slope of timing measurements, over a specific period of time, is greater than a threshold.

38. The method of claim 32, wherein the timing measurements and associated time stamps are transmitted to the network entity to enable to the network entity to verify that an actual location of the user device, represented by or associated with the transmitted timing measurements over a period of time, sufficiently matches or not a reported location of the user device.

39. An apparatus comprising:
at least one processor; and
at least one memory including computer program code;
the at least one memory and the computer program code configured to, with the at least one processor, cause the apparatus at least to:
receive, by a measuring device from a network entity, a request to perform location verification measurements for a user device in a wireless network;
receive, by the measuring device from the user device, reference signals;
determine, by the measuring device, a plurality of timing measurements and an associated time stamp for each timing measurement, for the received reference signals;
transmit, by the measuring device to the network entity, the timing measurements and associated time stamps, for use by the network entity to verify whether a reported location of the user device matches an actual location of the user device; and
receiving, by the measuring device, a configuration of the uplink sounding reference signals.

40. An apparatus comprising:
at least one processor; and
at least one memory including computer program code;
the at least one memory and the computer program code configured to, with the at least one processor, cause the apparatus at least to:
receive, by a network entity from a user device within a wireless network, a reported location of the user device;
transmit, by the network entity to a measuring device, a request to perform location verification measurements for the user device;
receive, by the network entity from the measuring device, timing measurements and an associated time stamp for each timing measurement measured by the measuring device for reference signals transmitted by the user device; and
verify, by the network entity, whether the reported location of the user device matches an actual location of the user device based at least on the received timing measurements and associated time stamps.

41. The apparatus of claim 40, wherein each of the transmitted timing measurements comprises a time of arrival measurement based on or including at least one of:
an absolute time of arrival of a reference signal received by the measuring device; or
a relative time of arrival of a reference signal received by the measuring device, wherein the relative time of arrival is provided with respect to a time reference, including with respect to at least one of:
a subframe boundary;
a system frame boundary;
a received reference signal received by the measuring device from a network node; or a common or known time reference.

42. The apparatus of claim 40 wherein the receiving, by the network entity from the measuring device, the timing measurements and associated time stamps comprises:
receiving, by the network entity from the measuring device the timing measurements and associated time stamps, in response to a trigger condition, associated with a mismatch between an actual location of the user device and the reported location of the user device, that is detected by the measuring device as being satisfied.

43. The apparatus of claim 42, wherein the trigger condition comprises at least one of the following:
one or more of the timing measurements, at or within a specific period of time, is greater than a threshold;
one or more of the timing measurements, at or within a specific period of time, is less than a threshold;
a difference between two of the timing measurements, over a specific period of time, is greater than a threshold;
a difference between two of the timing measurements, over a specific period of time, is less than a threshold;
a change of received timing measurements, associated with an actual or real location of the user device, is different by more than a threshold of an expected change of timing measurements, associated with a reported location of the user device;
a rate of change or slope of timing measurements, over a specific period of time, is less than a threshold; or
a rate of change or slope of timing measurements, over a specific period of time, is greater than a threshold.

44. The apparatus of claim 40, wherein the verifying comprises:
verifying, by the network entity that an actual location of the user device, represented by the received timing measurements over a period of time, sufficiently matches or not a reported location of the user device, represented by information indicating or associated with an expected change of timing measurements for the user device over the period of time.

45. The apparatus of claim 40, further comprising:
determining, by the network entity, information indicating or associated with an expected change of timing measurements for the user device, associated with the reported location of the user device; and
wherein the verifying comprises:
verifying, by the network entity, whether the reported location of the user device matches an actual location of the user device by comparing a change of the received timing measurements over a period of time, to the expected change of timing measurements for the user device over the period of time.

46. The apparatus of claim 44,
wherein the user device is connected to a serving network node via a serving satellite that is part of a non-terrestrial wireless network; and
wherein the information indicating or associated with an expected change of timing measurements for the user device over the period of time comprises at least satellite ephemeris information for the serving satellite.

47. The apparatus of claim 44, wherein the information indicating or associated with an expected change of timing measurements for the user device over the period of time comprises at least one of:
a plurality of expected timing measurements for the user device, associated with the reported location of the user device; or
an expected change of timing measurements for the user device, associated with the reported location of the user device.

48. The apparatus of claim 46, wherein the at least one memory and the computer program code configured to, with the at least one processor, further cause the apparatus at least to:
receive a reported location of the user device, wherein the verifying whether the reported location of the user device matches an actual location of the user device comprises:
determine, by the network entity, the expected change of timing measurements for the user device associated with the reported location of the user device over a period of time, based on the reported user device location and the satellite ephemeris information of the serving satellite;
determine, by the network entity, the change of the received timing measurements over the period of time; and
determine, by the network entity, whether the expected change of timing measurements over the period of time matches, within a threshold, the change of the received timing measurements over the period of time.

49. The apparatus of claim 40, wherein the verifying, by the network entity, whether the reported location of the user device matches the actual location of the user device based on determining at least one of the following:
one or more of the received timing measurements, over a specific period of time, is greater than a threshold;
one or more of the received timing measurements, over a specific period of time, is less than a threshold;
a difference between two of the received timing measurements, over a specific period of time, is greater than a threshold;
a difference between two of the received timing measurements, over a specific period of time, is less than a threshold;
a rate of change or slope of the received timing measurements, over a specific period of time, is less than a threshold; or
a rate of change or slope of the received timing measurements, over a specific period of time, is greater than a threshold.

50. The apparatus of claim 40, wherein the at least one memory and the computer program code configured to, with the at least one processor, further cause the apparatus at least to:
perform, by the network entity based on the verifying, an action with respect to the user device if the reported location of the user device does not match the actual location of the user device.

51. The apparatus of claim 50, wherein performing the action comprises performing at least one of the following:
sending, by the network entity, to the serving network node, a node within a core network or the user device, a message indicating that the reported location of the user device does not match the actual location of the user device; or
sending, by the network entity, to the serving network node or a node within the core network, a message requesting a disconnection of the user device or a reduction in services or a reduction in a quality of service provided by the serving network node to user device.
